(19) United States
(12) Patent Application Publication
(10) Pub. No.: US 2026/0106289 A1
(43) Pub. Date: Apr. 16, 2026

(54) Coin Cell Battery Holder

(71) Applicant: Brown Dog Gadgets LLC, Menomonee Falls, WI (US)

(72) Inventors: Joshua Zimmerman, Brookfield, WI (US); Peter Prodoehl, Milwaukee, WI (US); Andrew Wallus, Milwaukee, WI (US)

(21) Appl. No.: 19/355,615

(22) Filed: Oct. 10, 2025

Related U.S. Application Data
(60) Provisional application No. 63/706,810, filed on Oct. 14, 2024.

(51) Int. Cl. H01M 50/216

(52) U.S. Cl. CPC H01M 50/216

(57) ABSTRACT

A coin cell battery holder includes a housing with a first housing component and a second housing component; a cavity formed in one or both of the first housing component and the second housing component that is configured to receive a coin cell battery; and conductive materials such as electrical tape that are secured around the first housing component and the second housing component. One of the first housing component and the second housing component includes an opening formed therein, with the other of the first housing component and the second housing component including a threaded opening. A screw or other fastener is releasably inserted through the opening and then secured to the threaded opening. Once the housing components are secured to one another, the conductive materials deliver power from the coin cell battery to the exterior of the holder once a circuit is formed.

### CROSS REFERENCE TO A RELATED APPLICATION

This application claims the benefit of provisional patent application U.S. App. No. 63/706,810, filed on Oct. 14, 2024 and entitled “COIN CELL BATTERY HOLDER”, the entire contents of which are hereby expressly incorporated by reference into the present application.

### BACKGROUND AND SUMMARY

This invention relates to coin cell batteries, and more particularly to a holder that receives a coin cell battery.

Coin cell or button cell batteries are commonly used to power small electronics such as watches and vehicle key fobs. These batteries are also commonly used to power simple circuits. For instance, many curriculums teaching young individuals how electricity works include lessons involving the construction of simple circuits powered by coin cell batteries. Such circuits include a coin cell battery, various wiring, and a powered device, such as a light bulb. When the circuit is successfully constructed, the coin cell battery provides power to the light bulb, enabling a student to better understand the basic concepts of electricity.

Because coin cell batteries are small in size and circular in shape, it is desirable to encase the coin cell battery within the electronic or circuit being powered. For electronics such as watches and vehicle key fobs, the device is opened typically using a screwdriver, and the coin cell battery is inserted therein, after which the device is closed. Thereafter, it is difficult to access the coin cell battery without the use of a tool. However, when the most basic circuit is being created, there may not be a specific location within the circuit where the coin cell battery is actually encased.

The present invention provides a holder that encases the coin cell battery when it is used with a circuit, or in other instances, where the coin cell battery would not otherwise be encased. In accordance with an aspect of the invention, a housing is provided that includes two or more housing components that are releasably secured to one another. One or both of the housing components include a cavity that is configured and shaped to receive a portion of the coin cell battery. Additionally, the holder includes electrical tape or another conductive material that is associated with each of the housing components, and makes contact with the coin cell battery. This enables the coin cell battery to be secured within the housing, while the electrical tape enables a circuit to be created with external components such as wires and a powered device that are located outside of the housing.

In one embodiment, the housing includes first and second halves that are releasably secured to one another after the coin cell battery is properly located. Two strips of electrical tape may be wrapped around the first and second halves, such that certain portions of the electrical tape contact the coin cell battery, while other portions of the electrical tape are located on the exterior of the housing. Wires or other components can then contact the exterior portions of the electrical tape in order to create a circuit with a powered device.

The invention also contemplates a method of using the coin cell battery holder, substantially in accordance with the foregoing summary.

Other aspects, features and advantages of the invention will become apparent to those skilled in the art from the following detailed description and accompanying drawings. It should be understood, however, that the detailed description and specific examples, while indicating certain embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

A clear conception of the advantages and features constituting the present invention, and the construction and operation of typical mechanisms provided with the present invention, will become more readily apparent by referring to the exemplary, and therefore non-limiting, embodiments illustrated in the drawings accompanying and forming a part of this specification, wherein like reference numerals designate the same elements can be several views, and in which:

FIG. 1 is an isometric view of a coin cell battery holder containing a coin cell battery in a closed orientation in accordance with the present invention;

FIG. 2 is a sectional view of the closed coin cell battery holder along line 2-2 of FIG. 1;

FIG. 3 is an isometric view of the coin cell battery holder of FIGS. 1 and 2 in an opened configuration;

FIG. 4 is an isometric view of the coin cell battery holder of FIGS. 1-3 in an opened configuration with the coin cell battery removed;

FIG. 5 is an isometric view of the coin cell battery holder of FIGS. 1-4 with conductive electrical tape removed;

FIG. 6 is a top plan view of the coin cell battery holder of FIGS. 1-5; and

FIG. 7 is a bottom plan view of the coin cell battery holder of FIGS. 1-6; and

FIG. 8 is a simplified circuit drawing including the coin cell battery holder of FIGS. 1-7.

In describing the representative embodiment of the invention that is illustrated in the drawings, specific terminology will be resorted to for the sake of clarity. However, it is not intended that the invention be limited to the specific terms so selected, and it is to be understood that each specific term includes all technical equivalents, which operate in a similar manner to accomplish a similar purpose. For example, the words “connected,” “attached,” or terms similar thereto are often used. They are not limited to direct connection but include connection through other elements where such connection would be recognized as being equivalent by those skilled in the art.

### DETAILED DESCRIPTION

The present invention and the various features and advantageous details thereof are explained more fully with reference to the non-limiting embodiments described in detail in the following description.

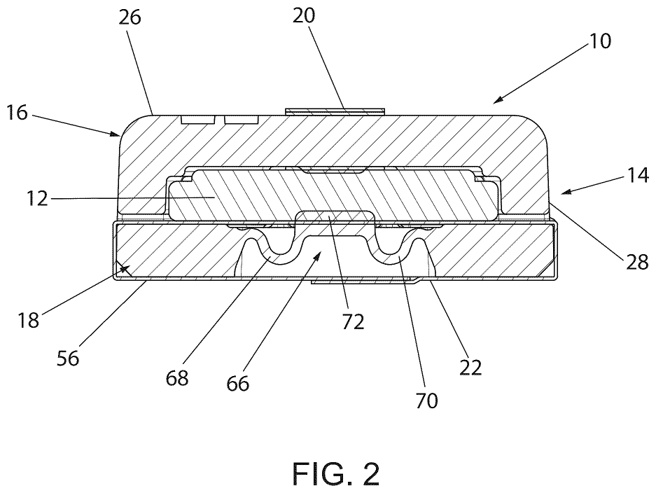

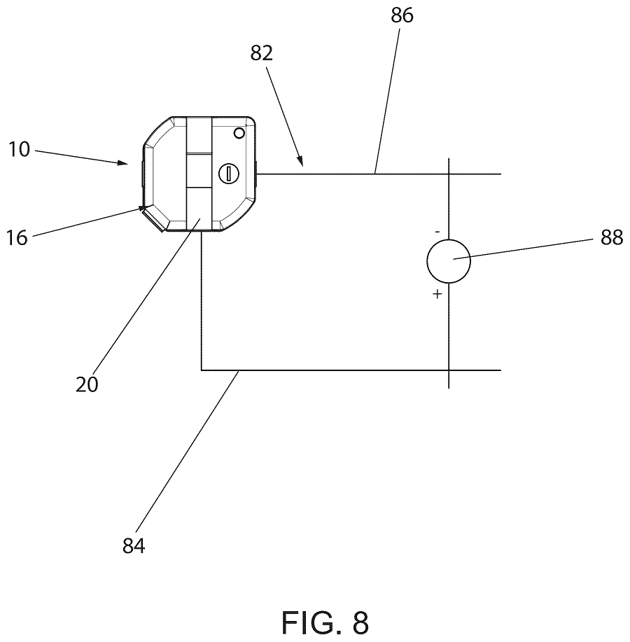

Referring generally to the figures, a coin cell battery holder 10 is provided that encases a coin cell battery 12 as best seen in FIG. 2. The coin cell battery holder 10 is adapted to be used in an application in which a coin cell battery 12 is used to provide power in an exposed circuit, such as in an educational kit or the like, as will further be described below. The coin cell battery holder 10 encases and encloses the coin cell battery 12, while still allowing electrical current to flow from the battery 12 to the exterior of the coin cell battery holder 10 when a circuit is completed as seen in FIG. 8.

Looking to the figures, the coin cell battery holder 10 includes a housing 14. As shown, the housing 14 includes a first housing component 16 and a second housing component 18. In the illustrated embodiment, the housing 14 is generally square shaped with three tapered corners, although it could similarly be formed into other sizes and shapes. Each housing component 16, 18 includes a conductive component that enables electrical current to be supplied from the coin cell battery 12 to the exterior of the housing 14. For instance, the illustrated coin cell battery holder 10 includes a first piece of conductive tape 20 that is wrapped around the first housing component 16 and a second piece of conductive tape 22 that is wrapped around the second housing component 18. As shown, the first conductive tape 20 is oriented perpendicular to the second conductive tape 22. Because the pieces of conductive tape 20, 22 wrap all the way around the housing component 16, 18, contact is made with the coin cell battery 12, which enables electrical current to be provided to the exterior of the housing 14 when a circuit is completed with other electrical components as will be further described below.

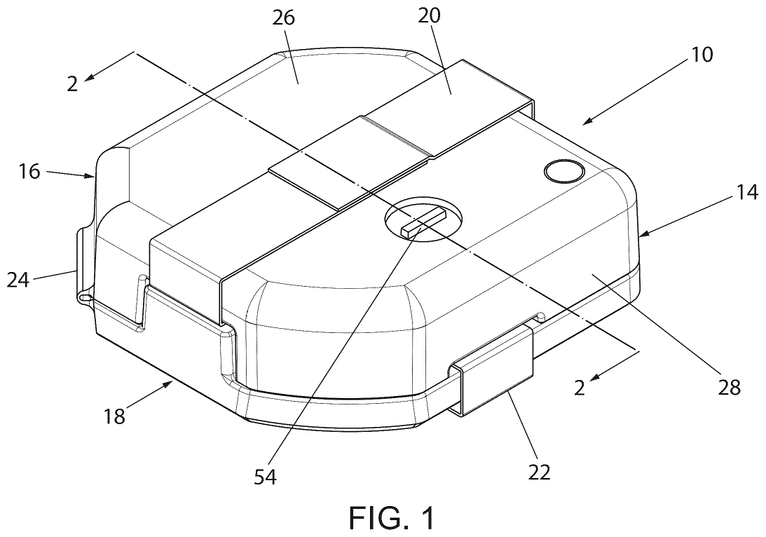

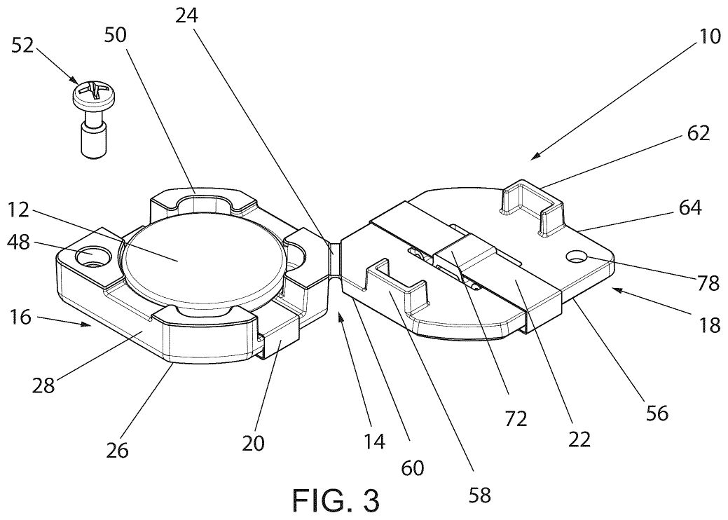

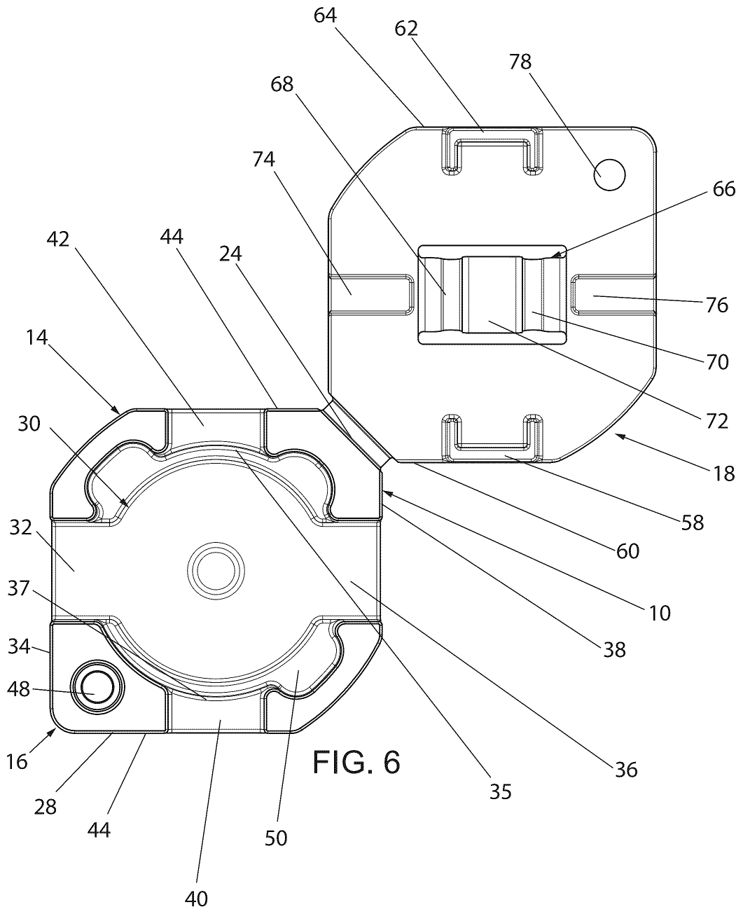

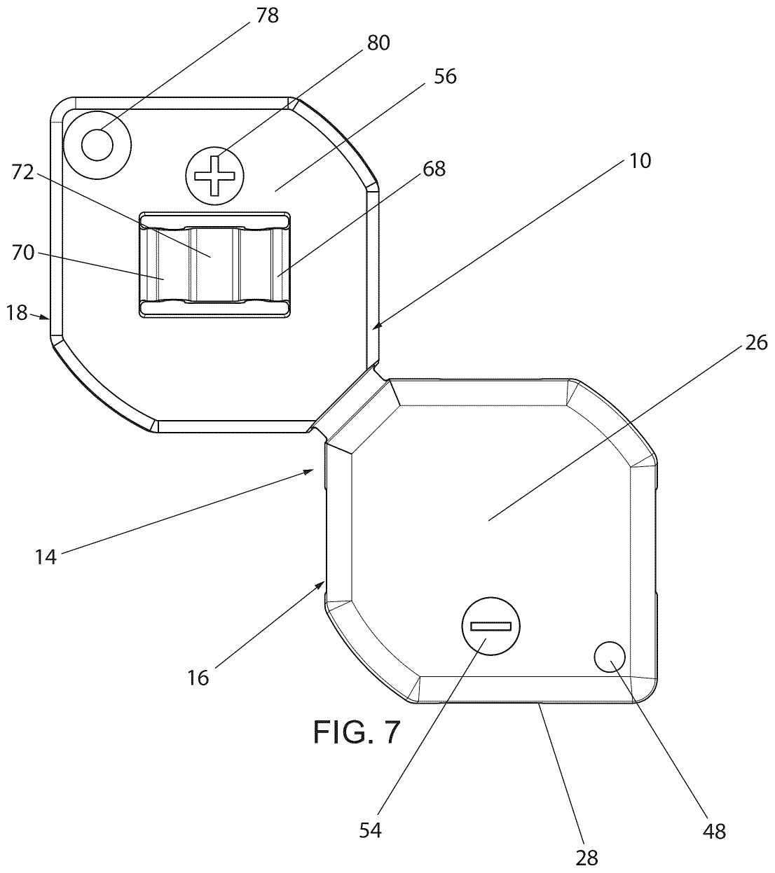

In the illustrated embodiment, the housing 14 is made of a single piece of material, with the housing components 16, 18 joined at a hinge 24. For instance, the housing 14 may be made of injection molded plastic, although other non-conductive materials could similarly be used. This simplifies both the manufacture of the housing 14, as well as the assembly the coin cell battery holder 10. The hinge 24 enables the housing components 16, 18 to easily be moved between an opened position (see FIGS. 3-7) and a closed position (see FIGS. 1 and 2). In other embodiments, the housing components 16, 18 may separately be manufactured and later assembled.

Next, each housing component 16, 18 will specifically be described. Of course, any of the features or components described in connection with the first housing component 16 may similarly be associated with the second housing component 18, and any features or components described in connection with the second housing component 18 may similarly be associated with the first housing component 16.

Turning to FIGS. 3-7, the first housing component 16 includes a planar outer wall 26, a perimeter wall 28, and mirrored first and second curvilinear inner walls 35, 37 that form a cavity 30 formed therebetween. The perimeter wall 28 extends along the perimeter of the planar outer wall 26, with the exception of a first gap 32 formed along one side 34 and a second gap 36 formed along another side 38 opposite the one side 34. The first housing component 16 is configured to receive the first conductive tape 20, which is wrapped around the first housing component 16 and oriented through the first gap 32 and the second gap 36.

Additionally, first and second notches 40, 42 are located on opposing sides 44, 46 of the first housing component 16. These notches 40, 42 provide clearance for the second piece of electrical tape 22 associated with the second housing component 18 when the holder 10 is in the closed position.

The first and second curvilinear inner walls 35, 37 of the perimeter wall 28 are curved and shaped such that the resulting cavity 30 formed therein is in the same general shape of the profile of the coin cell battery 12 as best seen in FIG. 3. The perimeter wall 28 may also include one or more divots 50 formed therein that help facilitate the removal of the battery 12 by a user, for instance using a fingernail, a screwdriver, or another small device to dislodge the battery 12 from the holder 10.

Additionally, as shown a threaded opening 48 is provided in the first housing component 16 to receive a screw 52, although other securement features could similarly be used to enable the second housing component 18 to be secured to the first housing component 16 once the coin cell battery 12 is properly located.

The first housing component 16 may also include a label 54 that helps a user identify to proper orientation of the battery 12 and use of the coin cell battery holder 10. As shown, a negative sign logo 54 is formed in planar outer wall 26 to designate that the first housing component 16 is associated with the negative polarity of the battery 10 for the purposes of designing and connecting a circuit.

Still looking to FIGS. 3-7, the second housing component 18 includes a planar outer wall 56, as well as first and second mounting tabs 58, 60 extending from first and second sides 62, 64 of the planar outer wall 56. The illustrated mounting tabs 58, 60 include three sidewalls, although other mounting tab configurations could similarly be used to ensure proper orientation of the second housing component 18 relative to the first housing component 16. The mounting tabs 58, 60 are configured to engage with the gaps 32, 36 formed in the first housing component 16. More specifically, when the coin cell battery holder 10 is moved to the closed orientation, the mounting tabs 58, 60 are nested within the gaps 32, 36, as best seen in FIG. 1. Additionally, there is sufficient clearance between the mounting tabs 58, 60 and the gaps 32, 36 to accommodate the electrical tape 20. Similarly, there is sufficient clearance between the second housing component 18 and the notches 40, 42 to accommodate the electrical tap 22.

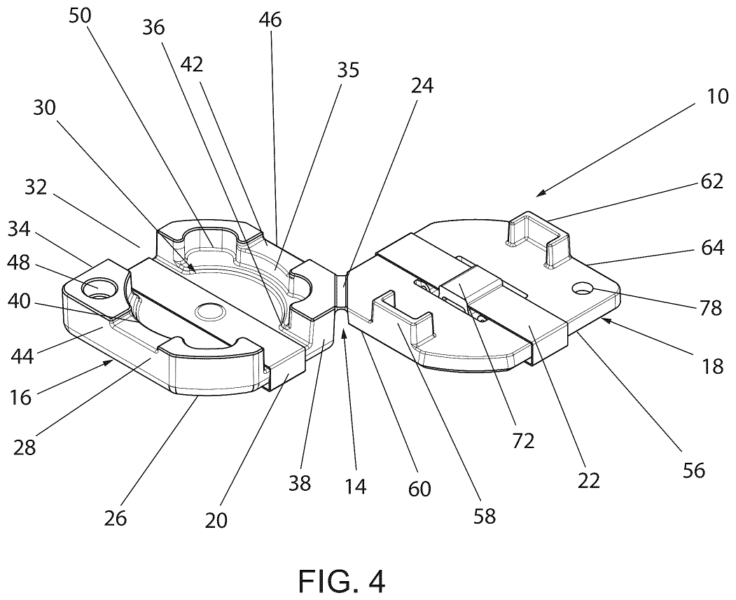

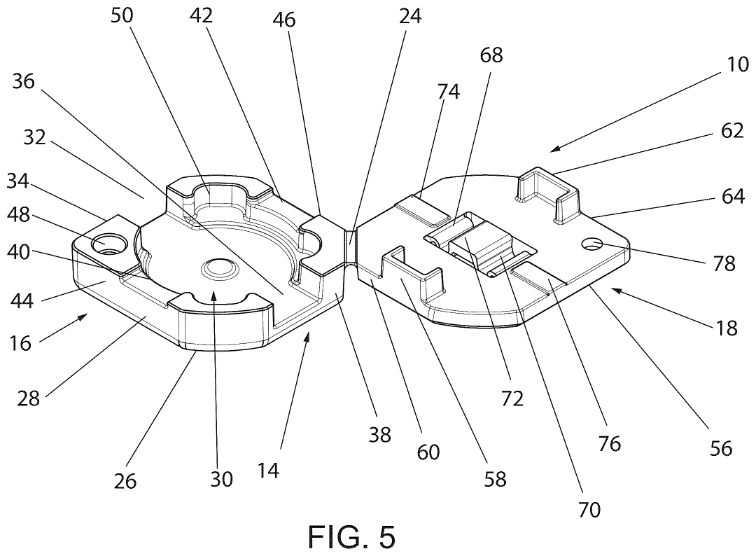

As best shown in FIGS. 2 and 5, the second housing component 18 also includes a spring clip 66 extending through the center of the planar outer wall 56. As shown, the spring clip 66 is substantially “W” shaped with two lower curved sections 68, 70 extending downwardly, and a planar central section 72 extending above planar outer wall 56 as also seen in FIG. 2. Use of the words downwardly and extending above are in connection with the orientation of the coin cell battery holder 10 in FIG. 2, but the holder 10 could be inverted or oriented in any desired way. Because the planar central section 72 extends above the planar outer wall 56 of the second housing component 18, the electrical tape 22 may be threaded between the planar central section 72 and the second housing component 18. See. FIGS. 3 and 4. In addition to securing the electrical tape 22 in place, the spring clip 66 also biases the coin cell battery 12 in the proper orientation to maintain contact with both pieces of the electrical tape 20, 22 to help ensure proper connectivity to the battery 12 once the circuit is completed.

Additionally, notches 74, 76 may extend into the second housing component 18 to help a user visualize, orient, and secure the electrical tape 22 relative to the second housing component 18 in the proper location.

The second housing component 18 also includes an opening 78 configured to receive the screw 52 or other securement fastener before it is inserted into the threaded opening 48 of the first housing component 16.

Further, the second housing component 18 may also include a label 80 that helps a user identify the proper orientation of the battery 12 and use of the coin cell battery holder 10. As shown, a positive sign logo 80 is formed in the planar outer wall 56 to designate that the second housing component 18 is associated with the positive polarity of the battery 10 for the purposes of designing and connecting a circuit.

Turning briefly to FIG. 8, the coin cell battery holder 10 is shown in a simplified circuit 58 that is commonly used for educational purposes. As shown, the circuit 82 also includes a first wire section 84, a second wire section 86, and an electrical component, as shown an LED light 88. The first wire section 84 is connected at one end to the LED light 88, and at the other end to the coin cell battery holder 10 at the piece of conductive tape 20. The second wire section 86 is connected at one end to piece of conductive tape 22 (not shown in FIG. 8, but on the underside of the coin cell battery holder 10) and at the other end to the LED light 88. In this way, there is a closed loop formed between the coin cell battery 12 contained within the holder 10, the wire sections 84, 86, and the LED light 88, which enables to coin cell battery 12 to power the LED light 88. Of course, the coin cell battery holder 10 could similarly be used with more complex circuits that are traditionally powered by coin cell batteries 12.

Use of the coin cell battery holder 10 will now be described. Initially, the first and second pieces of conductive tape 20, 22 are oriented relative to the first housing component 16 and the second housing component 18 as shown in the figures. Thereafter, the coin cell battery 12 is located within the cavity 30 as best seen in FIG. 3. Thereafter, the second housing component 18 is pivoted about the hinge 24 until the second housing component 18 abuts the first housing component 16. This includes the tabs 58, 62 being located within the gaps 32, 36. The housing components 16, 18 are then releasably secured together. As shown, this entails the screw 52 being inserted through the opening 78, after which the screw 52 is rotated to engage with the threaded opening 48. The coin cell battery holder 10 is then used to create a circuit 82. Once the coin cell battery 12 dies, the screw 52 can be removed, at which point the housing components 16, 18 are moved to the opened position. Thereafter, a user can insert a fingernail, screwdriver, or other tool into one of the divots 50 to dislodge the battery 12. The battery 12 can be replaced, and the holder 10 can be used again.

Although the best mode contemplated by the inventor of carrying out the present invention is disclosed above, practice of the present invention is not limited thereto. It will be manifest that various additions, modifications and rearrangements of the aspects and features of the present invention may be made in addition to those described above without deviating from the spirit and scope of the underlying inventive concept. The scope of some of these changes is discussed above. The scope of other changes to the described embodiments that fall within the present invention but that are not specifically discussed above will become apparent from the appended claims and other attachments. It is also understood that the invention disclosed and defined herein extends to all alternative combinations of two or more of the individual features mentioned or evident from the text and/or drawings. All of these different combinations constitute various alternative aspects of the present invention.

We claim:

1. A coin cell battery holder for holding a coin cell battery comprising:
a first housing component;
a second housing component releasably secured to the first housing component;
a cavity between the first housing component and the second housing component configured to receive a coin cell battery; and
one or more conductors configured to deliver electrical current outside of the first housing component and the second housing component when a circuit is complete.

2. The coin cell battery holder of claim 1, wherein the one or more conductors further comprises:
a first piece of conductive tape wrapped around the first housing component; and
a second piece of conductive tape wrapped around the second housing component.

3. The coin cell battery holder of claim 1, further comprising a hinge configured to enable the first housing component to rotate relative to the second housing component between:
an open configuration; and
a closed configuration where the coin cell battery is secured between the first housing component and the second housing component.

4. The coin cell battery holder of claim 3, further comprising:
a threaded opening formed in the first housing component;
an opening formed in the second housing component; and
a screw releasably inserted through the opening and secured to the threaded opening.

5. The coin cell battery holder of claim 1, wherein the first housing component further comprises:
a planar outer wall; and
a perimeter wall extending around a perimeter of the planar outer wall;
wherein the cavity is formed between the planar outer wall and the perimeter wall.

6. The coin cell battery holder of claim 5, wherein the first housing component further comprises at least one curvilinear inner wall.

7. The coin cell battery holder of claim 5, wherein the first housing component further comprises at least one gap formed in the perimeter wall.

8. The coin cell battery holder of claim 7, wherein the second housing component further comprises at least one mounting tab; and
wherein the at least one mounting tab is configured to be located within the at least one gap when the first housing component and the second housing component are in a closed configuration.

9. The coin cell battery holder of claim 1, wherein the second housing component further comprises:
a planar outer wall; and
a spring clip formed in the planar outer wall, the spring clip configured to bias the coin cell battery relative to the first housing component.

10. The coin cell battery holder of claim 9, wherein one of the conductors is secured to the spring clip.

11. A method of using a coin cell battery holder comprising the steps of:
inserting a coin cell battery into a cavity formed in a first housing component;
releasably securing a second housing component to the first housing component to surround the coin cell battery; and
disengaging the first housing component from the second housing component using a tool.

12. The method of using the coin cell battery holder of claim 11, further comprising the steps of:
wrapping a first conductive tape around the first housing component; and
wrapping a second conductive tape around the second housing component.

13. The method of using the coin cell battery holder of claim 12, further comprising the steps of inserting the second conductive tape through a spring clip extending from the second housing component.

14. The method of using the coin cell battery holder of claim 13, further comprising the step of biasing the coin cell battery towards the first housing component.

15. The method of using the coin cell battery holder of claim 12, further comprising the steps of:
pivoting the first housing component about a hinge towards the second housing component to a closed position;
securing the first housing component to the second housing component in the closed position;
releasing the second housing component from the second housing component; and
pivoting the first housing component about the hinge away from the second housing component to an opened position.

16. The method of using the coin cell battery holder of claim 11, further comprising the steps of:
orienting the first housing component relative to the second housing component to a closed position with the coin cell battery located therebetween;
inserting a screw through an opening formed in one of the first housing component and the second housing component;
rotating the screw into a threaded opening formed in the other of the first housing component and the second housing component to a locked position;
rotating the screw out of the threaded opening formed in the other of the first housing component and the second housing component to an unlocked position;
orienting the first housing component relative to the second housing component to an opened position; and
removing the coin cell battery from the cavity.

17. A coin cell battery holder system for holding a coin cell battery comprising:
a first housing component comprising:
a planar outer wall having a perimeter;
a perimeter wall extending around the perimeter of the planar outer wall; and
a cavity formed between the planar outer wall and the perimeter wall having a profile complementary to a coin cell battery;
a second housing component comprising a planar outer wall, the second housing component releasably secured to the first housing component;
a first conductor secured around the first housing component; and
a second conductor secured around the second housing component.

18. The system of claim 17, further comprising:
a first wire section engaged with the first conductor;
a second wire section engaged with the second conductor; and
an electrical component engaged with the first wire section and the second wire section.

19. The system of claim 17, wherein the first housing component further comprises a first gap formed in the perimeter wall;
wherein the second housing component further comprises a mounting tab extending from the second housing planar outer wall; and
wherein the gap is configured to receive the mounting tab.

20. The system of claim 17, further comprising:
an opening formed in one of the first housing component and the second housing component;
a threaded opening formed in the other of the first housing component and the second housing component; and
a fastener releasably inserted through the opening and secured to the threaded opening.
